(19) United States
(12) Patent Application Publication
(10) Pub. No.: US 2026/0051429 A1
(43) Pub. Date: Feb. 19, 2026

(54) Thermal Radiation Shield For A Superconducting Magnet

(71) Applicants: Massachusetts Institute of Technology, Cambridge, MA (US); Commonwealth Fusion Systems LLC, Devens, MA (US)

(72) Inventors: Alexey Radovinsky, Cambridge, MA (US); Alexander Zhukovsky, Brighton, MA (US)

(73) Assignees: Massachusetts Institute of Technology, Cambridge, MA (US); Commonwealth Fusion Systems LLC, Devens, MA (US)

(21) Appl. No.: 19/103,596

(22) PCT Filed: Apr. 26, 2024
(86) PCT No.: PCT/US2024/026460

§ 371 Date: Feb. 13, 2025

Related U.S. Application Data
(60) Provisional application No. 63/498,917, filed on Apr. 28, 2023.

(51) Int. Cl. H01F 6/04

(52) U.S. Cl. CPC H01F 6/04

(57) ABSTRACT

Described are structures and techniques for supporting a thermal radiation shield in a superconducting magnet. The thermal radiation shield can be supported off of a cold mass using low thermal conductivity structural supports. Structural supports, specifically thermal radiation shield supports and bumpers, may be installed between a cold mass and the radiation shield to mitigate deflections of the radiation shield. Thermal radiation shield supports are attached to both the cold mass and the radiation shield. Bumpers may be used in addition to thermal radiation shield supports and have a first end attached to either the cold mass or the thermal radiation shield and a second end not physically coupled to any structure.

### CROSS REFERENCE SECTION

This application claims benefit of U.S. Provisional Application No. 63/498,917 filed on Apr. 28, 2023 which application is hereby incorporated herein by reference.

### STATEMENT REGARDING FEDERALLY SPONSORED RESEARCH

Not Applicable.

### BACKGROUND

As known in the art, there are a number of existing approaches for the fabrication of low temperature superconducting (LTS) magnets. However, these existing approaches may not be satisfactory for use with high temperature superconducting (HTS) magnets.

### SUMMARY

This summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

High temperature superconducting (HTS) magnets open new opportunities for building high field magnets for a multitude of applications. HTS magnets have a critical current sensitivity which is small compared with the critical current sensitivity of low temperature superconducting (LTS) magnets at operating temperatures. This small current sensitivity permits HTS magnets to operate over temperature margins which are larger than temperature margins of LTS magnets. Further, HTS magnets operate at a higher temperature than LTS magnets. At such temperatures, the heat capacity of the materials comprising a cold mass of an HTS magnet is significantly higher than at LTS-compatible temperatures. Consequently, HTS magnets are less sensitive to local heating than LTS magnets. Further, HTS magnets provide sufficient cooling to cap the associated temperature rises. By reconsidering how these properties factor into the production of HTS magnets, the inventors have discovered improvements in the design and manufacturing of HTS magnets.

This disclosure relates to a thermal radiation shield for HTS magnets and related mounting structures and techniques. Disclosed herein are concepts, structures and techniques for supporting a radiation shield off a cold mass of an HTS magnet via structural supports (referred to herein as “thermal radiation shield supports” or “spacers”). The thermal radiation shield supports are disposed between and coupled to both the radiation shield and the cold mass. The cold mass may be coupled to a cryostat by supports, separate to the thermal radiation shield supports, which pass through the radiation shield.

Also disclosed are radiation shield bumpers (or more simply bumpers) disposed between and coupled to either the radiation shield or the cold mass (but not to both).

The thermal radiation shield can be coupled to the cold mass (via one or more thermal radiation shield supports) then inserted into a cryostat. Through use of the herein-described thermal radiation shield supports, the thermal radiation shield and cold mass may be assembled into a rigid sub-assembly before insertion into the cryostat. This approach greatly reduces complexity of the assembly process and thus improves assembly of the magnet compared with conventional approaches in which the cold mass and radiation shield are both coupled to the cryostat with the same supports.

Described herein is a thermal radiation shield and related mounting structures and techniques for use with superconducting magnets. The thermal radiation shield and related mounting structures and techniques may be particularly suited for use with superconducting HTS magnets. In embodiments, a thermal radiation shield support is connected only to a cold mass and a thermal radiation shield such that the cold mass mechanically supports the thermal radiation shield. In other words, the thermal radiation shield is attached to and mechanically supported by the cold mass via the structural supports. The cold mass (with the magnet) is separately mechanically supported by its own cold-to-warm supports, which do not contact the thermal radiation shield. In embodiments, thermal radiation shield supports are structural supports having a first end coupled to a cold mass and a second end coupled to the thermal radiation shield.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1A is a schematic diagram of a cold mass and a prior art thermal radiation shield support structure;

FIG. 1B is a schematic diagram of a cold mass and a prior art thermal radiation shield support structure having thermal intercepts;

FIG. 2 is schematic diagram of a prior art cold mass cooled by a cryocooler;

FIG. 3 is a schematic diagram of a high temperature superconducting magnet having thermal radiation shield supports and bumpers; and FIG. 4 is a schematic diagram of a high temperature superconducting magnet with thermal radiation shield structural supports and bumpers and cooled by a cryocooler.

### DETAILED DESCRIPTION

Described herein are techniques for coupling components in a superconductor magnet that are operated at different temperatures. In particular, a superconductor magnet may comprise a cold mass within a cryostat, in addition to a thermal radiation shield arranged between the cold mass and the cryostat. The ‘cold mass’ is a term that refers to the portion of the magnet that is superconducting during operation, typically including superconductor wires and/or tapes integrated into a structure and kept at a temperature of around 4 K during operation of the magnet. The cryostat forms the outside vacuum boundary for the cryogenic space within it and is typically held at room temperature, whereas the thermal radiation shield is arranged between the cold mass and cryostat and is kept at an intermediate temperature (e.g., around 77 K).

In a conventional superconducting magnet, described below, supports are arranged to connect the cold mass and the radiation shield to the cryostat. These supports mechanically support the cold mass and radiation shield while also minimizing heat leak from the cold mass through conduction between these components. Since cryogenic systems are much more efficient at cooling at 77 K versus 4 K, a system is conventionally arranged to provide greater cooling to the cold mass at the expense of producing larger heat loads on the radiation shield. As such, the radiation shield is conventionally arranged much closer to the cryostat than to the cold mass along a common support structure. However, assembling the cold mass and radiation shield to common supports inside the cryostat can be difficult.

Before describing the concepts and techniques for coupling components in a superconductor magnet, some introductory concepts in the context of conventional superconducting magnets are explained below.

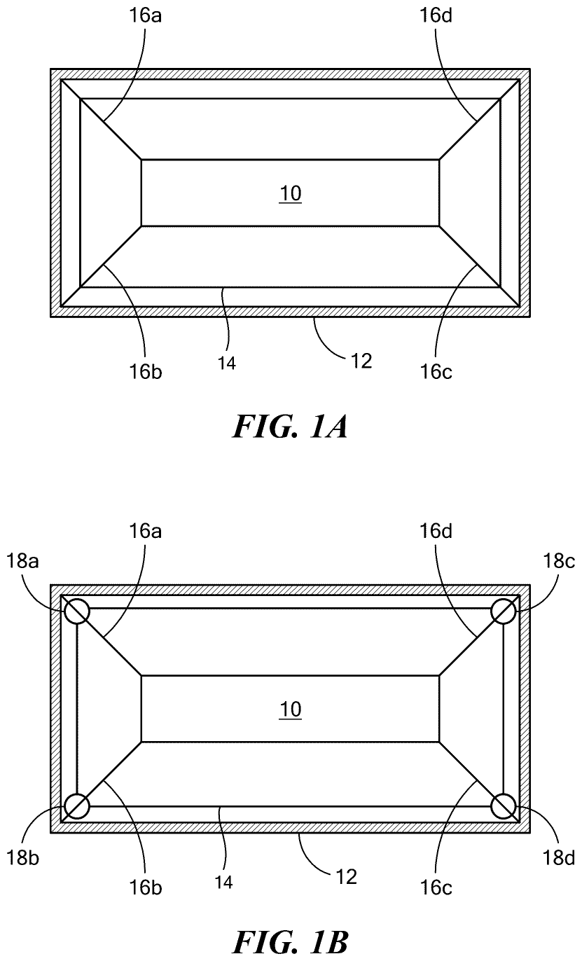

Referring now to FIG. 1A, a conventional superconducting magnet cold mass 10 is disposed inside a chamber of a cryostat 12 (with reference numeral 10 designating a boundary of the cryostatic chamber). The cold mass comprises superconducting wires integrated into a structural entity and kept at cryogenic temperature within the cryostatic chamber. For magnets comprising low temperature superconductor (LTS) material (so-called “LTS magnets”), the cryogenic temperature of the cold mass is in the range of about 4 K to about 9 K.

The cryostat provides a vacuum (typically in range of about 10⁻⁵ Torr or better) in the cryostatic chamber. The cryostat vacuum serves as a thermal insulator between the cold mass and the cryostat boundary which may be at or about ambient temperature. The cryostat walls are maintained at room temperature (RT), (about 300 K) during operation of the magnet.

As illustrated in FIG. 1A, a thermal radiation shield 14 is disposed about (e.g., around) the cold mass and is arranged between the cold mass and the cryostat wall. The thermal radiation shield is typically kept at an intermediate temperature corresponding in many cases to about a boiling temperature of liquid nitrogen (LN₂) at a pressure about equal to atmospheric pressure (e.g., in the range of about 77 K to about 80 K). At the intermediate temperature (e.g., 70 K-80 K in an LTS system), the possible cooling power of the cryostat is in the range of hundreds of watts, whereas at the low cryogenic temperature (4 K, typical for LTS cold masses), it is in low single digits of Watts.

Cold-to-warm (CW) supports 16a-16d are connected to the cold mass, the thermal radiation shield and the cryostat and serve to support the cold mass and the thermal radiation shield within the cryostat. Thus, in conventional designs, the same CW supports 16a-16d support both the cold mass and the radiation shield. The connected combination of the cold mass, radiation shield and CW supports may be referred to as a cold mass-thermal radiation shield-CW support subassembly. The CW supports 16a-16d are directly coupled to both the thermal radiation shield and the cold mass. That is, CW supports 16a-16d directly support both the thermal radiation shield and the cold mass.

This approach, however, complicates magnet design and given the often tight spacing (or gaps) between the radiation shield and cold mass this approach also poses significant challenges when assembling the cold mass-thermal radiation shield-CW support subassembly into the cryostat.

Specifically, the fact that two bodies (i.e., the cold mass and the radiation shield) which, in many cases, are heavy bodies), are supported by the same CW supports makes handling this sub-assembly and the final securing of the sub-assembly inside the cryostatic chamber challenging. These challenges increase when cryocoolers are incorporated into the design.

Additionally, the CW supports serve as tension links, securing the position of the cold mass and the radiation shield inside the cryostat while at the same time, reducing, and ideally minimizing, heat leak by thermal conduction between the three components (i.e., between the cold mass, the radiation shield and the cryostat walls) which are each kept at different temperatures.

In a typical assembly process, the radiation shield is inserted into the cryostat, then the cold mass is inserted inside of it. This assembly technique poses challenges since it obscures the view of the cold mass and restricts access to critical points inside the radiation shield. To resolve these difficulties in the assembly process, multiple cutouts are made in the radiation shield. These cutouts are later patched to restore the integrity of the radiation shield. Magnet assembly of this kind requires specialists with high technical skills, especially when the radiation shield is covered by a multi-layer insulation for reduction of the heat load from cryostat walls to the radiation shield.

In the case of an LTS magnet, this complex assembly procedure is primarily driven by two factors. First, the length of the CW supports between the cold mass and the radiation shield is required to provide appropriate thermal resistance. In LTS magnets utilizing constant cross section CW supports, the general practice support is to divide the length of the CW support by an intermediate temperature (77 K-80 K), intercept in an approximate proportion of 1 (on the side of the cryostat) to 3 (on the side of the cold mass). Second, the need to reduce heat conduction to the cold mass to the level of low single-digit watts requires that the radiation shield is placed much closer to the cryostat than to the cold mass.

To further reduce radiation loads on the cold mass, some LTS magnets (e.g., LTS magnets operated at temperatures below 4 K), may use several radiation shields. In some embodiments, the radiation shields may be enclosed in one-another and cooled to gradually decreasing temperatures (e.g., about 77 K to about 40 K to about 20 K).

Different from the radiation thermal loads, heat transferred via CW supports may be defined by: (1) the differential warm-to-cold temperature; (2) the thermal conductivity of the CW supports over this range of warm-to-cold temperatures; and (3) physical dimensions of the CW supports (e.g., length and cross sectional area of the CW supports).

Referring now to FIG. 1B in which like elements of FIG. 1A are provided having like reference designations, as described above, the CW supports 16a-16d provide a thermal path from cryostat 14 to cold mass 10 through the radiation shield and heat may flow along this path from the cryostat and radiation shield to the cold mass. To reduce heat flow from the cryostat to the cold mass, and as illustrated in FIG. 1B, thermal intercepts 18a-18d may be disposed in the path. Thus, thermal intercepts 18a-18d further manage heat flow and further thermally insulate the cold mass from heat flux.

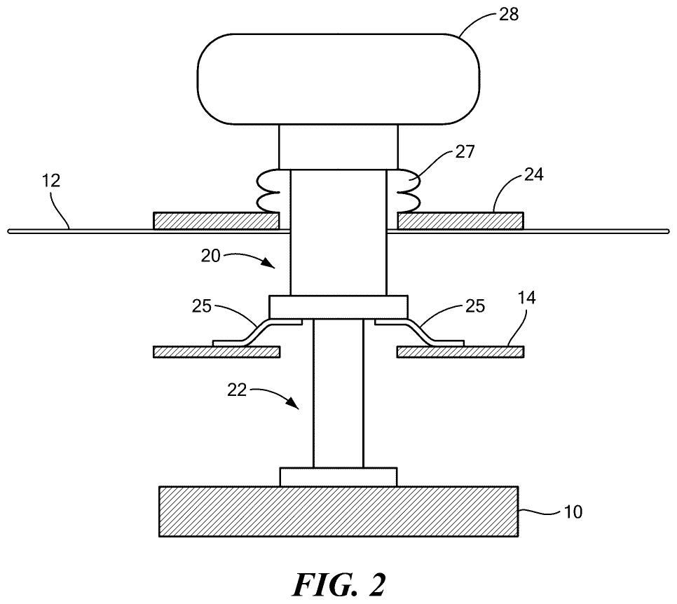

Referring now to FIG. 2, in which like elements of FIGS. 1A, 1B are provided having like reference designations, the system includes a two-stage cryocooler having a first stage 20 thermally coupled to the radiation shield 14 and a second stage 22 thermally coupled to cold mass 10. A cryostat flange 24 provides a hermetic seal for a cryostatic chamber in which the cold mass resides.

The difficulties of connections between components increase due to the need to accommodate independent movements of cold mass 10 and a radiation shield 14. Such independent movements may occur, for example, due to differences in thermal contractions of the supported items (e.g., differences in thermal contractions between the radiation shield and the cold mass).

In embodiments, the structure (e.g., stem or barrel) of the cryocooler (in many cases) cannot sustain forces in excess of about 10 kg. Thus, conventional designs often incorporate flexible connections (e.g., flexible thermal bridges) 25 between a flange 22a of the first stage of the cryocooler and the radiation shield 14 and flexible connections 27 (e.g., a bellows) between the cryostat flange 24 and the cryocooler 28. The need for flexible connections complicates the design and assembly of the system and also reduces cooling efficiency of the thermal radiation shield by adding more thermal links and contacts.

In accordance with the concepts, systems, structures and techniques described herein, the inventors have recognized that in case of an HTS magnet, a number of factors enable a different approach to installing a cold mass and thermal radiation shield in a cryostat. First, the operating temperature of the cold mass when the cold mass comprises an HTS superconductor is higher than that of an LTS superconductor magnet, usually at around 20 K (versus around 4 K). Second, at this higher temperature there is a higher amount of cooling power available. For example, at 20 K, advanced cryocoolers can deliver up to 100 W of cooling power (compared with a few Watts at 4 K). Third, at higher temperatures, HTS superconductors have larger temperature margins than LTS superconductors, despite limited variations of local temperature.

As will be described in detail below, the inventors have recognized structures and techniques to reduce (and ideally minimize) heat loads on a cold mass. In accordance with the concepts described herein, the inventors have recognized that structural supports can be utilized to support a radiation shield directly off a cold mass. The structural supports may be made of any low thermal conductance materials, which can be used at cryogenic temperatures considered herein and having mechanical strength/integrity sufficient to withstand forces to which cold mass-to-radiation shield connections may be subject.

This is in contrast to prior art approaches in which both the cold mass and radiation shield are connected to and supported by the same CW supports (such as CW supports 16a-16c described above in conjunction with FIGS. 1A, 1B) which CW supports are also connected to a cryostat structure (e.g., a wall of the cryostat) as described above in conjunction with FIGS. 1A, 1B.

The inventors have recognized that supporting a thermal radiation shield off a cold mass via structural supports in accordance with the concepts described herein can help mitigate deflection of the radiation shield, reduce heat conduction, and enables assembly of the magnet in a manner that is mechanically simpler than conventional approaches.

It may be noted the techniques for supporting a thermal radiation shield off a cold mass described herein may not achieve the same result (and may not be available for) a superconductor magnet comprising an LTS superconductor. As described above, the cooling power available to a cold mass at 4 K (which is required for LTS superconductors) leads to multiple requirements for the design of the system, including a need to thermally decouple the radiation shield from the cold mass. This need arises because the operational temperature margin, being the difference between the critical temperature and the operating temperature, is around 1-2 K in an LTS magnet. In addition, the heat capacity of the cold mass materials gets smaller as the operating temperature decreases. As a result, an LTS magnet is extremely sensitive to even a very small heat flux, which may cause a portion of the LTS magnet to be heated above its critical temperature and quench. Because of these temperature effects in an LTS magnet, the radiation shield must be thermally decoupled from the cold mass by positioning it between the cold mass and the room-temperature cryostat and attaching it to the cold-to-warm supports. This limits the mechanical design space available.

In an HTS magnet, however, the operational temperature margin is much larger (e.g. around 10 K or more), and since the operational temperature of an HTS magnet is higher than the operational temperature of an LTS magnet, the heat capacity of the cold mass materials is also higher in an HTS magnet than an LTS magnet. As a result, the mechanical design space (i.e. the possible design options) for the thermal radiation shield in an HTS magnet is larger (e.g. wider) than for an LTS magnet, and—as recognized by the inventors—allows for the techniques described herein to support the thermal radiation shield off a cold mass.

In some embodiments, structural supports are described for a radiation shield in a high temperature superconducting (HTS) magnet. The radiation shield can be mechanically supported (hereinafter, simply ‘supported’) off of the cold mass using low thermal conductivity structural supports. Structural supports, specifically bumpers and spacers, may be installed between the cold mass and the radiation shield to mitigate the deflections of the radiation shield. Spacers are attached to the cold mass and the radiation shield, bumpers may be used in addition to spacers and may be attached to either the cold mass or the thermal radiation shield. During normal operation the bumpers may contact either the cold mass or the radiation shield, leaving a small gap on the opposing side which interrupts heat transfer through the bumper. These structural supports enable improved assembly. By placing the supports onto the cold mass, then installing the radiation shield and inserting the sub assembly into the cryostat, areas of the cold mass are more easily accessible during the assembly and less cutouts in the radiation shield are needed.

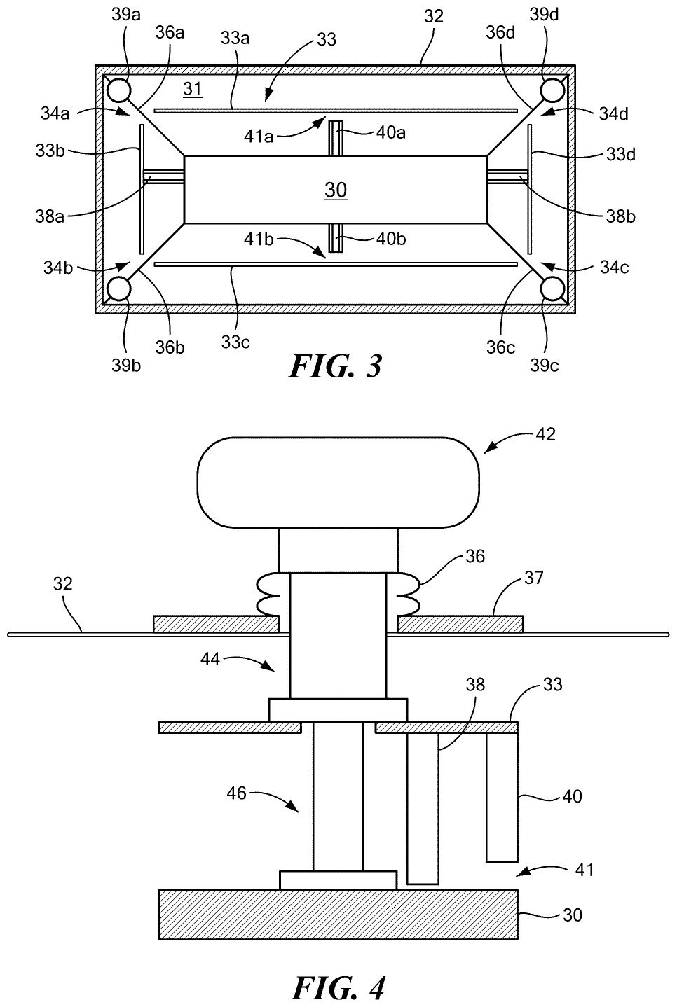

Referring now to FIG. 3, a superconducting magnet cold mass 30 is disposed within a cryostatic chamber of a cryostat 32 (with reference numeral 32 representing a boundary of the cryostatic chamber and reference numeral 31 representing the cryostatic chamber space within or defined by the boundary). Cryostat 32 is configured to provide cooling to: the cold mass (including the magnet); the radiation shield; the radiation shield supports; thermal intercepts (if any); and cooling of cold-to-warm supports. In embodiments, a cryocooler may be used to provide such cooling.

Cold mass 30 comprises superconducting wires integrated into a structural entity and kept at cryogenic temperatures within the cryostatic chamber. For HTS magnets, the cryogenic temperature is above about 9 K and is typically about 20 K.

The cryostat provides a vacuum (typically in range of about 10⁻⁵ Torr or better) in the cryostatic chamber. The cryostat vacuum serves as a thermal insulator between the cold mass and the cryostat boundary which may be at or about ambient temperature. That is, the region outside the cryostatic chamber may be maintained at room temperature (RT), (about 300° K) during operation of the magnet.

A thermal radiation shield 33 is disposed about (e.g., around) the cold mass 30. Thermal radiation shield 33 has openings 34a-34d provided therein. Cold-to-warm (CW) supports 36a-36d pass through the openings and extend between the cold mass and the cryostat and serve to support the could mass within the cryostatic chamber.

The CW supports 36a-36d are not directly coupled to the thermal radiation shield. That is, in contrast to prior art approaches, CW supports 36a-36d do not directly support the thermal radiation shield. Rather, CW supports 36a-36d provide structural support sufficient to hold (or maintain) at least the weight of the cold mass such that the cold mass is in a desired position within the cryostat. The CW supports 36a-36d also provide structural support to secure (or hold or maintain) the cold mass in a desired position (or range of positions) when the cold mass is subject to forces. The physical (e.g., mechanical), electrical and thermal characteristics of the CW supports may be selected (and ideally, optimized) to reduce a heat load presented to the cold mass (e.g., such as the heat load provided by the RT cryostat). Such optimization may account for a number of factors including, but not limited to: geometrical and structural characteristics of the CW supports; geometrical and structural characteristics of materials in the CW supports; temperature dependence of the heat conduction coefficients of materials comprising the CW supports; and brittleness of support material at cryogenic temperatures. Usual optimization is defined by the ratio of yield strength of the warm end of the CW support to the heat transfer coefficient for the given warm-to-cold temperature drop.

The thermal radiation shield 33 is supported off the cold mass via one or more thermal radiation shield supports (sometimes also referred to herein as “structural supports” or “spacers”) with two such thermal radiation shield supports 38a, 38b being shown in the example embodiment of FIG. 3. Each thermal radiation shield support has a first end attached or otherwise secured to the cold mass and a second end attached or secured to the thermal radiation shield. This attachment can occur through permanent attachment means (e.g., via welding) or through removable attachment means (e.g., bolts, nuts, or fasteners) or other additional attachment mechanisms. With this approach, the thermal radiation shield is firmly, without any flexibility, attached to the cold mass forming a rigid radiation shield-cold mass sub-assembly.

The thermal insulation of the radiation shield 33 may require using thermal radiation shield supports 38a, 38b having additional layers of non-structural materials with very low thermal conductivity, e.g., a glass-reinforced plastic or a glass fiber-reinforced plastic (e.g., fiberglass), a polyimide film (e.g. Kapton® a registered trademark of E.I. Du Pont De Nemours and Company), synthetic polymers with amide backbones (e.g. nylon) or low thermal conductance ceramics.

It should be appreciated that although in the example embodiment of FIG. 3, thermal radiation shield supports are shown on only two opposing sides of the cold mass, in embodiments, thermal radiation shield supports may be on only one side of the cold mass. Further, in embodiments, thermal radiation shield supports may be all sides of the cold mass.

The particular number and positioning (i.e., location) of the thermal radiation shield supports coupled to the cold mass is dependent upon the needs of the particular application. In some embodiments in which the magnet comprises HTS material, N number of thermal radiation shield supports may be used where N is an integer equal to or greater than 1. The particular number and positioning (i.e. location) and geometry (e.g., length, cross-sectional shape and area) of the thermal radiation shield supports coupled to the cold mass is dependent upon a variety of factors including but not limited to the weight of the thermal radiation shield and the size of the forces to which the thermal radiation shield will be subject at any mode of operation.

In some embodiments, the thermal radiation shield supports may be equally distributed (e.g., equally spaced) along a particular direction of the cold mass (e.g., along an axial direction or along a radial direction or along an axis of the cold mass). In some embodiments, the thermal radiation shield supports may not be equally distributed (i.e., equally spaced) along a particular direction of the cold mass.

After reading the description provided herein, those of ordinary skill in the art will appreciate the number and positioning of thermal radiation shield supports in a particular application.

In embodiments, one or more thermal intercepts may optionally be disposed in or thermally coupled to one or more of the cold mass supports. In the example of FIG. 3, each of CW supports 36a-36d has a respective one of thermal intercepts 39a-39d thermally coupled thereto. In embodiments, some or all of CW supports 36a-36d may optionally have one or more thermal intercepts thermally coupled thereto. It is noted that thermal Intercepts 39a-39d differ from those described in conjunction with FIG. 1B since in the embodiment of FIG. 3 the temperature differential of T_{warm}−T_{cold} is different compared with the temperature differential of T_{warm}−T_{shield} and T_{shield}−T_{cold} in the embodiment of FIG. 1B.

In embodiments, one or more bumpers, generally denoted 41, may be disposed between the cold mass and the thermal radiation shield with two bumpers 40a, 40b being shown in the example embodiment of FIG. 3. Bumpers 40a, 40b may be used to mitigate the deflection of the thermal radiation shield (or further mitigate the deflection of the thermal radiation shield in combination with the one or more thermal radiation shield supports). In embodiments, the bumpers may be fabricated from substantially the same as material as the thermal radiation shield supports, (e.g., low thermal conductivity materials) and are installed or disposed between the cold mass and the radiation shield. In embodiments, the bumpers may be fabricated from a material which is different than the thermal radiation shield support material. In embodiments, bumpers may be fabricated from a material which is not a low thermal conductivity material since at normal operation there is a vacuum gap which interrupts heat transfer from the radiation shield to the cold mass through the bumper. A thermal short through the bumper may occur under conditions which are not considered normal operating conditions (e.g., during a quench or not normal unbalanced mechanical force) at which point the magnet would need to be shut down.

During normal magnet operation, the bumpers contact only one of these entities. That is, one end of each of the bumpers is secured to either the cold mass or the thermal radiation shield (but not both), leaving a gap such as gaps 41a, 41b, (generally referred to as 41) in FIG. 3. Thus, in this example, the bumpers are selected having a length such that a second end of each bumper is spaced a predetermined distance from a surface of the thermal radiation shield to provide a gap. That is, the length of the bumper is selected to leave a gap 41 and the size of the gap is selected to limit the amount of deformation in the thermal radiation shield. Gaps 41a, 41b need not be the same size.

In the example embodiment of FIG. 3, the bumpers are illustrated as being secured to the cold mass. That is, each bumper has a first end attached or secured to the cold mass and a gap exist between a second end of the bumper and a surface of the thermal radiation shield. The bumper end which is attached may be attached using bolts, screws, fasteners, welding or other additional attachment mechanisms (e.g., any of the attachment techniques or attachment means described above in conjunction with attachment of the thermal radiation shield supports). In embodiments, one or more bumpers may be secured the cold mass and one or more bumpers may be secured to the thermal radiation shield (that is, it is not necessary that all bumpers be coupled to the same structure; it may be desirable to attach some bumpers to the cold mass while attaching other bumpers to the thermal radiation shield). In embodiments, there may be 2, 4, or more bumpers as is appropriate to suit the needs of a particular application.

During a quench, the thermal radiation shield may be deformed due to electromagnetic forces caused by eddy currents developed during a magnet quench and a portion of the deformed thermal radiation shield may contact the bumpers, thus reducing its deflections and limiting (and ideally, preventing) the number and or size of deformations, damage and even destruction, which may occur in the thermal radiation shield.

The particular number (if any) and positioning of the bumpers between the cold mass and the thermal radiation shield is dependent upon the needs of the particular application. Number and position of bumpers are chosen to prevent unpermitted deformations and stresses in the radiation shield as well as to prevent thermal shorts between the shield and cold mass at any mode of operation (cooling, charging the superconducting magnet, operation under nominal currents, discharging, warming and a quench).

In some embodiments, thermal radiation shield supports and bumpers may be used together in a single system. In some embodiments only thermal radiation shield supports may be used (i.e., some embodiments may not include bumpers). For example, thermal radiation shield supports may be placed at the locations in which bumpers are shown in FIG. 3 and bumpers omitted or moved to a different location.

In an embodiment, the thermal radiation shield supports and bumpers may be relatively small in size comparison to the size of cold mass 30. Using rigid spacers in combination with bumpers permits making the radiation shield to be thinner and to be made of higher thermal conductivity materials and in many cases, without or with less intrusions into the radiation shield.

It should be noted that the position of the radiation shield between the cold mass and the cryostat is not defined by the locations of the thermal intercepts on the CW supports. Similarly, the thermal intercepts on the CW supports are not defined by their points of connection to the radiation shield and can be arranged at any point along the length of the CW supports and independent of the location of the radiation shield. Thermal intercepts are optional and may not be present. Flexible connections to a cooling source may be used instead of thermal intercepts or in addition to thermal intercepts.

In embodiments where the radiation shield is made up of segments (e.g., segments 33a-33d in FIG. 3), the CW supports may be inserted or otherwise disposed in the gaps between the segments. In embodiments where the radiation shield is cohesive, i.e., not made up of segments, the CW supports may be inserted or otherwise disposed into cutouts in the radiation shield.

Referring now to FIG. 4, in which like elements of FIG. 3 are provided having like reference designations, thermal radiation shield supports 38 and bumpers 40 may be utilized in designs having cryocoolers 42 coupled or attached to the cryostat wall 32 and configured to cool superconducting magnet 30. A cryostat flange 37 provides a hermetic seal for a cryostatic chamber in which the cold mass 30 resides. In case of cooling by 2-stage cryocoolers, the thermal radiation shield supports 38 and bumpers 40 remove the need for a flexible connection between a first stage 44 of the cryocooler and the radiation shield 33. However, the flexible connection (such as those described above in FIG. 2) can still be used. Both stages 44, 46 of the two-stage cryocooler can be connected to the respective cooled entities firmly, the first stage 44 to the radiation shield 33 and the second stage 46 to the cold mass 30. In FIG. 4, a thermal radiation shield support 38 and an optional bumper 40 are illustrated as being disposed between radiation cold mass 30 and thermal radiation shield 33. Although in the schematic diagram of FIG. 4, it appears thermal radiation shield support 38 and bumper 40 are adjacent to each other, it should be noted that in practice, bumpers 40 are spaced apart from thermal radiation shield supports 38. For example, bumpers and thermal radiation shield supports may be spaced apart along a longitudinal axis of a cold mass and/or spaced apart on sides (e.g., on opposite sides) of a cold mass and/or spaced apart in an axial direction around a cold mass. After reading the disclosure provided herein, one of ordinary skill in the art will appreciate how to space bumpers and thermal radiation shield supports.

Through the use of thermal radiation shield supports 38, the assembly of an HTS magnet is a much simpler and low-risk task compared with prior art techniques. The thermal radiation shield is first built around the cold mass, which is then installed in the cryostat. The thermal radiation shield is firmly, without any flexibility, attached to the cold mass forming a rigid radiation shield-cold mass sub-assembly. Once the radiation shield-cold mass sub-assembly is installed into the cryostat, the CW supports and thermal intercepts are installed. The CW supports pass through one or more gaps or cutouts in the thermal radiation shield and do not contact the thermal radiation shield as discussed previously.

By first connecting or otherwise placing or installing the thermal radiation shield supports onto the cold mass before installation in a cryostat and, then connecting or otherwise placing or installing the thermal radiation shield to the thermal radiation shield supports, areas of the cold mass are easily accessible during assembly. Further, the radiation shield can be installed after the cold mass, meaning the radiation shield may need less cutouts in order to install the cold mass. This approach results in a need for less patching and fewer gaps in the thermal radiation shield compared with the amount of patching and number of gaps needed using prior art techniques. Furthermore, by forming a rigid radiation shield-cold mass sub-assembly, as described, assembly and disassembly, tracing of instrumentation and anchoring it to the thermal radiation shield, installation of multilayer insulation, as well as inspection of components and structures is also much easier compare with prior art techniques.

Although reference may be made herein to particular materials, it is appreciated that other materials having similar functional and/or structural properties may be substituted where appropriate, and that a person having ordinary skill in the art would understand how to select such materials and incorporate them into embodiments of the concepts, techniques, and structures set forth herein without deviating from the scope of those teachings.

Various embodiments of the concepts, systems, devices, structures and techniques sought to be protected are described herein with reference to the related drawings. Alternative embodiments can be devised without departing from the scope of the concepts, systems, devices, structures, and techniques described herein. It is noted that various connections and positional relationships (e.g., over, below, adjacent, etc.) are set forth between elements in the above description and in the drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship. The term “connection” can include an indirect “connection” and a direct “connection.” The term “direct contact” means that a first element, such as a first structure, and a second element, such as a second structure, are connected without any intermediary elements.

As an example of an indirect positional relationship, references in the present description to providing a structure, part or apparatus “A” over structure, part or apparatus “B” include situations in which one or more intermediate structures, parts or apparatus (e.g., part “C”) may be between structure, part or apparatus “A” and structure, part or apparatus “B” as long as the relevant characteristics and functionalities of structure, part or apparatus “A” and structure, part or apparatus “B” are not substantially changed by the intermediate structure 20 part(s) or apparatus.

The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs.

The term “one or more” and is understood to include any integer number greater than or equal to one, i.e. one, two, three, four, etc. The terms “a plurality” and more than one are understood to include any integer number greater than or equal to two, i.e. two, three, four, five, etc.

References in the specification to “one embodiment, “an embodiment,” “an example embodiment,” etc., indicate that the embodiment described can include a particular feature, structure, or characteristic, but it should be understood that every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one of ordinary skill in the art to affect such feature, structure, or characteristic in connection with other embodiments whether or not explicitly described.

For purposes of the description hereinafter, the terms “upper,” “lower,” “right,” “left,” “vertical,” “horizontal,” top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about”may include the target value.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The term “substantially equal” may be used to refer to values that are within ±20% of one another in some embodiments, within ±10% of one another in some embodiments, within ±5% of one another in some embodiments, and yet within ±2% of one another in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1-33. (canceled)

34. A system comprising:
a cold mass comprising a superconducting magnet;
a thermal radiation shield;
one or more thermal radiation shield supports connected to the cold mass and the thermal radiation shield; and
one or more cold-to-warm supports configured to:
connect to the cold mass; and
pass through the thermal radiation shield without connecting to the thermal radiation shield.

35. The system of claim 34, wherein the one or more cold-to-warm supports further comprise one or more thermal intercepts.

36. The system of claim 34, further comprising one or more bumpers connected to one of: the cold mass; or the thermal radiation shield.

37. The system of claim 36, wherein the one or more bumpers comprises a low thermal conductivity material.

38. The system of claim 34, further comprising a cryostat thermally coupled to and configured to cool the cold mass and the thermal radiation shield.

39. The system of claim 38, wherein the cryostat comprises a two-stage cryocooler.

40. The system of claim 38, wherein:
the cold mass and the thermal radiation shield are disposed in the cryostat; and
the one or more cold-to-warm supports are further configured to connect to a wall of the cryostat.

41. The system of claim 34, wherein the superconducting magnet is a high temperature superconducting (HTS) magnet.

42. The system of claim 34, wherein the one or more thermal radiation shield supports comprise a low thermal conductivity material.

43. The system of claim 34, wherein the one or more thermal radiation shield supports are connected to the cold mass with at least one of: one or more bolts; one or more screws; or one or more fasteners.

44. The system of claim 34, wherein the thermal radiation shield comprises a plurality of electrically conductive shield segments connected via one or more non-electrically conductive structures.

45. The system of claim 34, wherein the cold mass, the thermal radiation shield, and the one or more thermal radiation shield supports comprise a rigid subassembly.

46. The system of claim 34, further comprising a cryostat, and wherein:
the superconducting magnet comprises high temperature superconductor (HTS) material and is arranged within the cryostat;
the thermal radiation shield is arranged within the cryostat and coupled to the superconducting magnet; and
the one or more cold-to-warm supports are configured to couple the superconducting magnet to the cryostat, the one or more cold-to-warm supports passing through one or more gaps in the thermal radiation shield.

47. The system of claim 46, wherein each of the one or more cold-to-warm supports passes through a respective gap in the thermal radiation shield.

48. The system of claim 46, wherein the thermal radiation shield comprises a plurality of segments.

49. A system comprising:
a cryostat;
a superconductor magnet comprising high temperature superconductor (HTS) material, and arranged within the cryostat;
a thermal radiation shield arranged within the cryostat and coupled to the superconductor magnet via a plurality of spacers; and
a plurality of supports coupling the superconductor magnet to the cryostat, the plurality of supports passing through one or more gaps in the thermal radiation shield.

50. The system of claim 49, wherein the plurality of supports pass through the one or more gaps in the thermal radiation shield without contacting the thermal radiation shield.

51. The system of claim 49, wherein each of the plurality of supports passes through a respective gap in the thermal radiation shield.

52. The system of claim 49, further comprising a plurality of bumpers arranged between the superconductor magnet and the thermal radiation shield, each of the plurality of bumpers being coupled to either the superconductor magnet or the thermal radiation shield.

53. The system of claim 49, wherein the thermal radiation shield comprises an electrical conductor.
